(19) United States
(12) Patent Application Publication
(10) Pub. No.: US 2007/0185954 A1
(43) Pub. Date: Aug. 9, 2007

(54) Method of conveying geographically conditioned information to vehicle or individuals

(75) Inventor: Mikael Willgert, Spanga (SE)

Correspondence Address: ALFRED J MANGELS, 4729 CORNELL ROAD, CINCINNATI, OH, 452412433, US

(73) Assignee: TAGMASTER AB, Kista (SE)

(21) Appl. No.: 10/570,644

(22) PCT Filed: Aug. 30, 2004
(86) PCT No.: PCT/SE04/01243

§ 371 Date: Nov. 6, 2006

(30) Foreign Application Priority Data
Sep. 3, 2003 (SE) 0302362-9
Dec. 29, 2003 (SE) 0303550-8

(51) Int. Cl. G06F 15/16

(52) U.S. Cl. 709/203

(57) ABSTRACT

A method of transmitting geographically governed information to automotive vehicles or to individuals, based upon the location of the vehicles or individuals. The exact or approximate position of the vehicle or the individual is determined in relation to permanently spaced units for radio communication between those units and a vehicle-carried or an individual-carried communications unit. A computer and associated database contains information that includes different data relevant to different geographical areas. The computer sends relevant information to a receiving unit in each and every one of those vehicles or individuals whose position has been determined, and in accordance with the geographical area in which the vehicle or the individual is located.

### BACKGROUND OF THE INVENTION

1. Field of the Invention

The present invention relates to a method of conveying geographically governed information.

2. Description of the Related Art

Systems are known with which information concerning traffic situations in towns, cities, etc., can be transmitted, for example, by conventional radio transmission. One problem in this regard is that the information transmitted covers an entire area, normally an entire city or town, that is within range of the radio transmitter. This means that the information is relevant solely to those motorists that are located in the vicinity of a traffic accident for instance. The information is not relevant with respect to other motorists.

There is, of course, a need to provide information, for instance information related to a traffic situation, on a more local basis, with the aid of a system that delivers different types of information to different geographical areas, for instance to different parts of a city or town, or to different parts of a larger geographical area, or to deliver some other type of information. There is also a need to provide information of a different type to that related to a traffic situation, for instance information concerning service stations and restaurants disposed along a road network. Such information is generally displayed on signs placed along the roads or highways concerned.

There is also a need to transmit information at a given time point prior to the subject of said information being discovered, noticed, or taking place.

### SUMMARY OF THE INVENTION

The present invention satisfies those requirements with regard to traffic situations and also with regard to other information directed to motorists. The subject matter described below can also be applied to individuals, i.e., to the presentation of information to separate individuals.

Accordingly, the present invention relates to a method of transmitting geographically governed information to automotive vehicles or to individuals, depending on the location of said vehicle or individual. The method includes determining the exact or approximate position of the vehicle or the individual in relation to fixedly disposed units, for radio communication between the units and a communications unit in the vehicle or carried by the individual . A computer and associated database contains information which includes different data relevant to different geographical areas. The computer sends relevant information to a receiving unit in each and every one of the vehicles whose positions have been determined, and in accordance with the geographical area in which the vehicle or the individual is located.

### BRIEF DESCRIPTION OF THE DRAWINGS

The invention will now be described in more detail, partly with reference to an exemplifying embodiment of the invention shown in the accompanying drawings, in which

FIG. 1 is a diagrammatic illustration of a communications link;

FIG. 2 is a block diagram illustrating the application of the invention in accordance with a first embodiment;

FIG. 3 is a block diagram illustrating the application of the invention in accordance with a second embodiment;

FIG. 4 is a block diagram illustrating the application of the invention in accordance with a third embodiment; and

FIG. 5 is a diagrammatic illustration of various roads in a road network.

### DESCRIPTION OF THE PREFERRED EMBODIMENTS

The present invention relates to a method of sending geographically governed information to automotive vehicles or to individuals, depending on the location of the vehicles or individuals

According to the invention, the exact or approximate position of the vehicle or individual is determined relative to spaced fixed units, for radio communication between the units and a vehicle-carried or individual-carried communications unit.

Known to the art are several different kinds of automatic identification systems that use radio frequencies, so-called RFID (Radio Frequency Identification), and which include identification tags (ID-tags) and communicators. Applicants provide such identification systems. In one such system, shown in FIG. 2, the communicators 10-12 constitute the fixedly disposed units for radio communication between the units and a vehicle-carried communications unit in the form of an ID-tag or transponder 6, 8, 9.

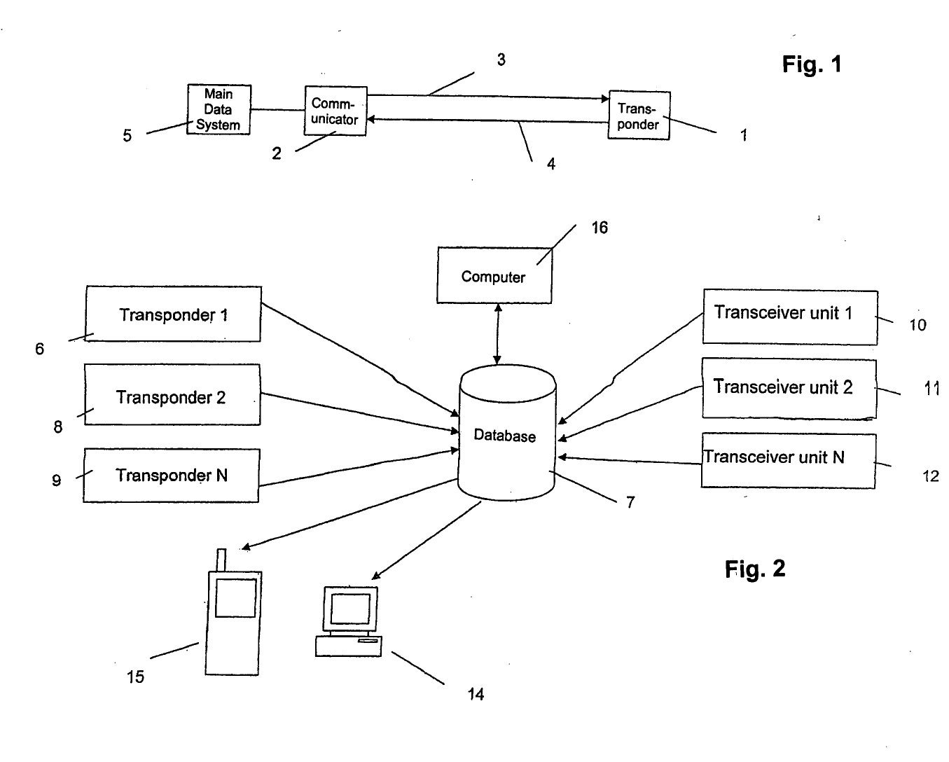

Also, shown in FIG. 1 is a vehicle identification communications unit. The communications unit includes a transponder 1 and a communicator in the form of a transceiver unit 2. The communicator 2 is adapted to send an inquiry signal 3 to the transponder 1. The transponder is adapted to receive the inquiry signal and to reflect and modulate the signal. The communicator 2 is adapted to receive the reflected signal 4 and to decode its information content.

Referring once again to FIG. 2, the ID-tag 6, 8, 9 is conveniently applied to the inner surface of the windshield of the vehicle to be identified. The vehicle identity can be read by a communicator 10-12 at a given smaller distance from the vehicle, such as a distance of from 5-10 meters, for instance. Depending on the design of the system, it is also possible to read and write-in other information contained in the ID-tag with the aid of the communicator 10-12, in addition to reading the identity of the vehicle.

The relatively short range makes possible communication with the ID-tags within a geographically limited communications area.

According to a first embodiment of the invention, one such transponder system is used when practicing the invention.

The transceiver unit 10, 11, 12 is suitably placed at a portal that extends over all traffic lanes. The transceiver thus reads the transponders that pass through the portal.

The transceiver unit 10, 11, 12 is connected to a main data system that includes a database 7 and a computer 16. The connection to the main data system 5, and 7, 16 can be a cable connection, a radio connection, a W-Lan connection, a GSM/GPRS/G3 connection, or the like.

Because the vehicle passes a transceiver unit 10-12, which reads the vehicle-carried transponders 6, 8, 9 and results in read data being transferred to the computer, the vehicle will be identified in the database 7.

According to the invention, computer 16 and its associated database 7 in the main data system contains information that includes various items of data that are relevant to different geographical areas.

The information can concern traffic situations at different places, advertisements, information on the distance to the next gas station, restaurants, etc., or other information relevant to a vehicle-passenger with respect to the geographical position of the vehicle.

According to the present invention, the computer 16 sends the relevant information to a receiving unit 14, 15 in each of the vehicles whose position has been determined, and based upon the geographical area in which the vehicle is located.

According to one preferred embodiment, the receiving unit includes a mobile telephone 15 or a vehicle-carried computer 14. The telephone 15 or computer 14 is adapted to receive an information-carrying signal via a mobile telephone network, for instance in the form of an SMS-message, an MMS-message, an E-mail message, or a voice message.

According to a first embodiment of the invention, each vehicle is equipped with a communications unit in the form of a transponder 6, 8, 9 that can be read by means of respective permanently placed or fixed units . The fixed units are in the form of a communicator which includes a transceiver unit 10, 11, 12 and sends an inquiry signal to the transponder. The transponder (6, 8, 9) is designed to answer the inquiry signal and then to transfer the transponder-related identification information to the communicator, which receives that identification information. Communicators are placed along the stretches of road located in the various geographical areas in which it is desired to present information, wherein each communicator that reads a transponder sends the identity information to the computer 16, and the geographically governed information is then sent to the vehicle-carried receiving unit.

By “each vehicle” is meant each vehicle that is connected to the system included by the invention. For instance, it is conceivable that the owner of a vehicle subscribes to the system against the payment of a certain fee and therewith receives a transponder. In that regard, an ID-number can be stored in the transponder and tied to the owner of the vehicle in database 7, together with the mobile telephone number to the vehicle-carried receiving unit.

According to one preferred embodiment of the invention, the transponder is a so-called RFID-transponder.

According to a highly preferred embodiment of the invention the approximate position of the vehicle and the direction in which it is being driven are determined when the vehicle-carried transponder 6, 8, 9 has been read by two or more mutually sequentially located communicators 10-12.

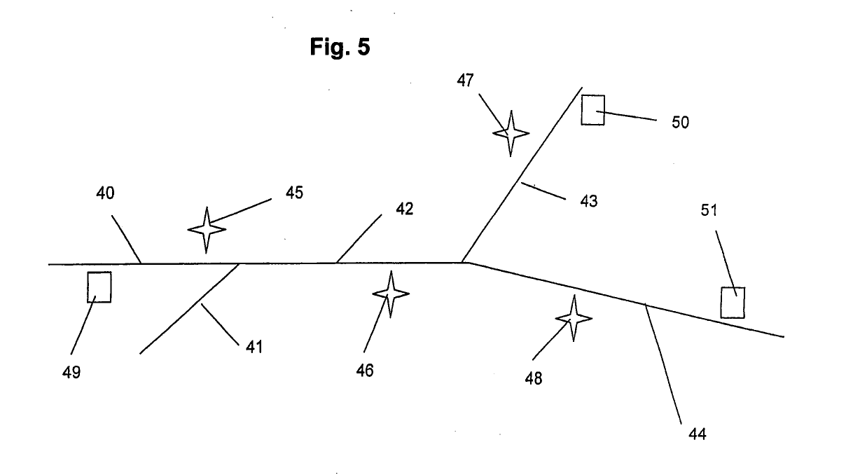

Two or more mutually sequential readings enable the data system to determine the travel direction of the vehicle and its average speed. That knowledge can be used as a basis for deciding which information is to be sent to the vehicle-mounted receiving unit 14, 15. That is illustrated in FIG. 5, in which the reference numerals 40-44 identify different stretches of a road, the reference numerals 45-48 denote the permanently placed units for radio communication, the reference numerals 49, 50 denote restaurants, and the reference numeral 51 denotes a gas filling station.

For instance, when the vehicle has been read by communicator 46 and then by communicator 45, the inventive system is able to send a message to the effect that a restaurant 49 lies within the range of 5 km, for instance. The same applies to a vehicle that has been read by communicator 46 and then again by communicator 47. When a vehicle has been read by communicator 46 and then by communicator 48, the system according to the present invention is able to send a message to the effect that a filling station, gas station 51, lies within the range of 3 km, for instance.

However, two messages can be sent to a vehicle that passes at 45, namely a message to the effect that a restaurant 49 is situated along road 40 to the left in FIG. 5 of the present location of the vehicle, and a message to the effect that a restaurant 50 is situated along road 43. That information can then be evaluated by the driver or passengers of the vehicle.

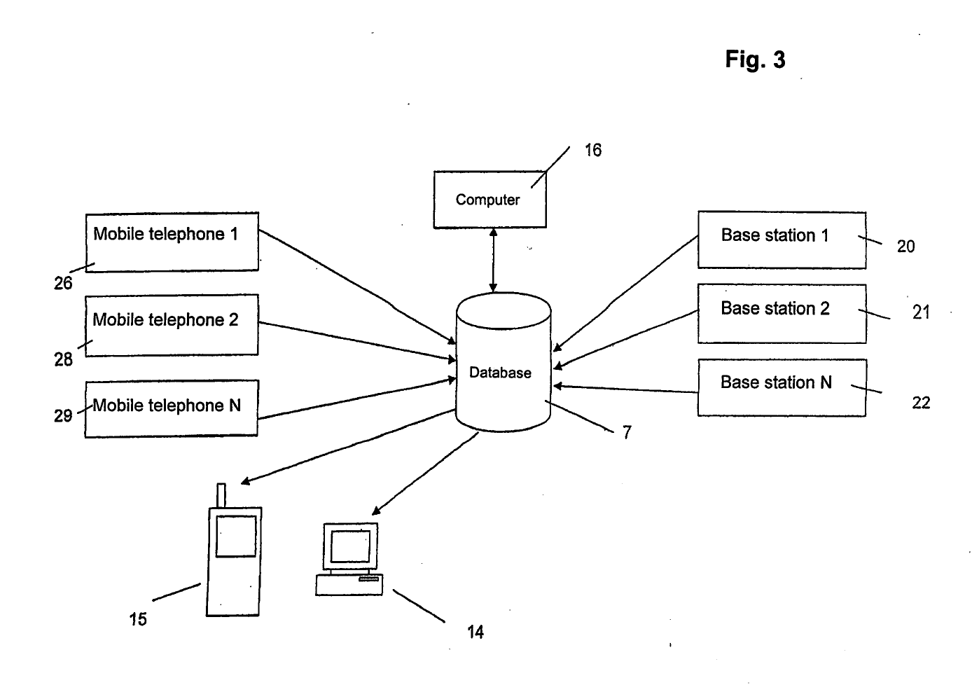

According to a second embodiment of the invention, shown in FIG. 3, each vehicle is equipped with a communications unit in the form of a mobile telephone 26, 28, 29. The approximate position of the telephone is established through the medium of the permanently placed units in the form of base stations 20-22 belonging to a mobile telephone system, wherein information relating to the position of the mobile telephone 26, 28, 29 identified by respective base stations 20-22 is transferred to computer 16, and wherein the geographically governed information is then sent to the vehicle-carried receiving unit, the mobile telephone 26, 28, 29. Thus, in the case of this embodiment the mobile telephones and base stations are used to determine the exact or approximate position of the vehicle, instead of transponders and communicators.

Correspondingly to the method illustrated in FIG. 5, it is preferred in the case of this second embodiment that the approximate position of the mobile telephone 26, 28, 29 and the direction in which the vehicle travels are determined when the mobile telephone is in the area covered by a base station after having been located within the area covered by an adjacent base station. The reference numerals 45-48 in FIG. 5 denote base stations that are relevant in this latter case.

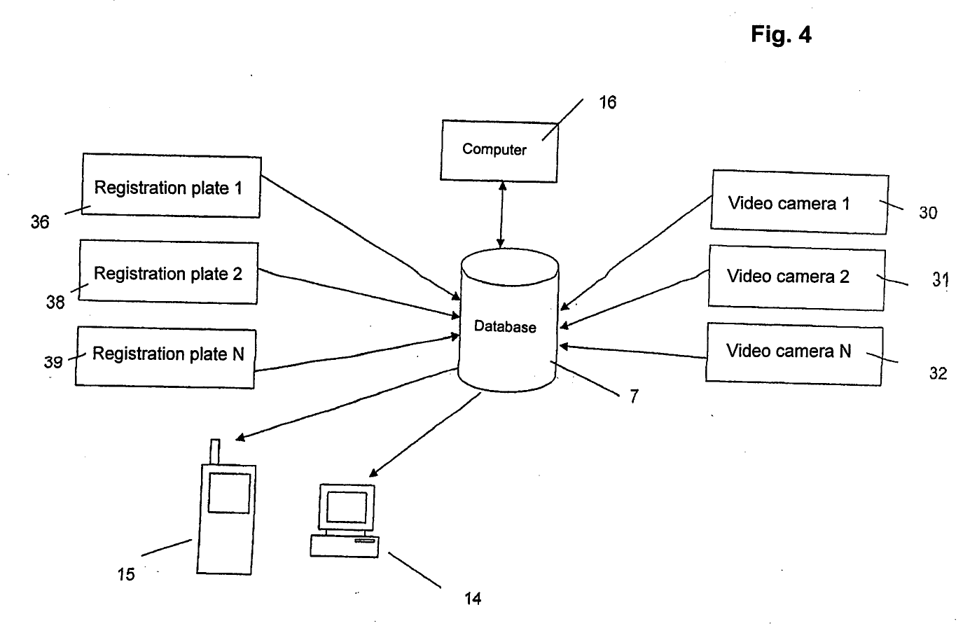

According to a third embodiment, shown in FIG. 4, each vehicle is equipped with a communications unit in the form of a vehicle number plate or registration plate 36, 38, 39, whose registration number can be read optically by means of the permanently placed units in the form of video cameras 31-32. These video cameras are spaced along stretches of road in different geographical areas within which it is desired to send information. Each video camera that reads a registration number transfers that number to the computer 16, after which the geographically governed information is then sent to the vehicle-carrying receiving unit 14, 15.

According to a preferred embodiment, some of the geographically governed information is sent to respective receiving units 14, 15 only at given time intervals.

According to a further embodiment of the invention some of the geographically governed information is sent to respective receiving units 14, 15 only once or only a predetermined number of times.

Thus, the present invention allows information to be sent to vehicles in accordance with their geographical positions at that time.

It has been said above that such information can relate to traffic situations at different places, advertisements, information relating to distances to gas stations, restaurants, etc., or other vehicle/passenger relevant information referable to the geographical position of the vehicle.

For instance, traffic situation information can relate to accidents, road works, traffic queues, alternative routes, and so on. Gas station information can also concern vehicle service stations, eating places, etc. Advertisements can relate to taverns, restaurants, hypermarkets, pleasure parks, things worth seeing, and so on.

Further embodiments are concerned with an individual as opposed to a vehicle; see FIGS. 2 and 3. According to one embodiment concerning individuals, essentially all individuals have about their person a mobile telephone 26, 28, 29 that is able to function as a transponder in the above-mentioned respect. For example, an individual who moves in the proximity of a base station 20-22 located close to a large store or the like can receive on his her/her mobile telephone 26, 28, 29 advertising material sent from the store. That means that the individual receives information about a product which he/she then purchases at precisely that store. Another example is one where an individual approaches the platform of a subway station and passes a base station 20-22 and receives information via his/her mobile telephone 26, 28, 29 as to the departure of the next train to a given destination, or information relating to a stoppage in subway traffic.

According to another embodiment, an individual can be equipped with a transponder 6, 8, 9 which is not seated in some other technical device, such as a mobile telephone, and which communicates with communicators as described above. The transponder, however, can be included in some other technical device, such as a mobile telephone.

Although the invention has been described above with reference to a number of embodiments thereof, it will be obvious that the structural design of the various embodiments can be modified without a change in function.

It will therefore be understood that the present invention is not restricted to the above-described exemplifying embodiment thereof, since variations can be made within the scope of the accompanying claims.

What is claimed is:

1. A method of transmitting geographically governed information to automotive vehicles or to individuals, based upon the location of said vehicle or individuals, said method comprising the steps of: determining an approximate position of the vehicle or the individual in relation to permanently spaced communication units for radio communication between said units and a vehicle-carried or an individual-carried communication unit; providing a computer and associated database for containing information which includes different data relevant to different geographical areas; determining positions and direction of movement of a vehicle or of an individual by at least two of said permanently spaced communication units; sending from the computer said relevant data to a receiving unit in each vehicle or to each individual based upon a geographical area in which the vehicle or the individual is located; wherein said receiving unit is at least one of a mobile telephone and a computer that receives a signal sent via a mobile telephone network and that receives said relevant data in the form of at least one of an SMS-message, an MMS-message, an E-mail message, and a voice message.

2. A method according to claim 1, including the steps of: equipping a vehicle or a person with a communications unit in the form of a transponder that can be read by said permanently spaced communication units in the form of a communicator that includes a transceiver unit; sending from a communicator an inquiry signal to a transponder; responding by the transponder to the inquiry signal to transfer transponder-related identification information to the communicator, which receives the identification information; placing communicators at places located in various geographical areas in which it is desired to present geographically governed information; wherein each communicator that receives a response from a transponder sends the identification information to said computer; and sending said geographically governed information to said receiving unit.

3. A method according claim 2, including the step of: determining an approximate position of the vehicle or of the individual and a travelling direction when the vehicle-carried or the individual-carried transponder has responded to at least two or more mutually sequentially located permanently spaced communication units.

4. A method according to claim 2, wherein the transponder is an RFID-transponder.

5. A method according to claim 1, including the steps of: equipping a vehicle or individual with a communications unit in the form of a mobile telephone; establishing an approximate position of said mobile telephone through the medium of said permanently spaced communication units in the form of base stations belonging to a mobile telephone system; transferring information relating to a position of a mobile telephone identified by a respective base station to said computer; sending said geographically governed information to said mobile telephone carried by the vehicle or by said individual; and determining an approximate position of the mobile telephone and a travelling direction when the mobile telephone is in an area covered by a base station after having been located within the area covered by an adjacent pre-ceding base station.

6. A method according to claim 1, including the step of sending geographically governed information to respective receiving units only at given time intervals.

7. A method according to claim 1, including the step of sending geographically governed information to respective receiving units only a predetermined number of times.
